(19) United States
(12) Patent Application Publication
(10) Pub. No.: US 2013/0009464 A1
(43) Pub. Date: Jan. 10, 2013

(54) System and Method for Controlling a Battery Pack Output Contactor

(75) Inventors: Paul W. Firehammer, Saline, MI (US); Brian C. Moorhead, Willis, MI (US); Brian D. Rutkowski, Ypsilanti, MI (US)

(73) Assignee: A123 SYSTEMS, INC., Waltham, MA (US)

(21) Appl. No.: 13/636,319

(22) PCT Filed: Mar. 23, 2011
(86) PCT No.: PCT/US2011/029523

§ 371 Date: Oct. 2, 2012

Related U.S. Application Data
(60) Provisional application No. 61/316,459, filed on Mar. 23, 2010.

(51) Int. Cl. B60L 11/18; H02J 1/00; H01H 47/00

(52) U.S. Cl. 307/9.1; 307/140; 307/80

(57) ABSTRACT

Systems and methods for controlling a contactor of a battery pack are disclosed. In one embodiment, the coil of the contactor is controlled by a power supply. Further, the contactor coil holding current may be adjusted in response to vehicle drive mode.

### TECHNICAL FIELD

The present description relates to controlling a battery pack output contactor. In one embodiment, the battery pack provides power to propel a vehicle.

### BACKGROUND AND SUMMARY

The number of battery powered and battery assisted vehicles continues to grow as the price of fossil fuels increases. Further, battery powered vehicles may reduce emissions of undesirable gases such at CO₂, HC, and NO_{X}. Rather than simply stringing together a group of battery cells, it may be beneficial to integrate battery cells and battery controls into a battery pack. For example, a battery pack may be installed into a vehicle with relative ease as compared to installing individual cells and battery controls because the installer has fewer connectors to attach during battery pack installation. Further, a battery pack may provide additional benefits in that a boundary may be established between the battery pack and the vehicle and its surroundings. In one embodiment of a battery pack, electrical contactors within the battery pack provide electrical isolation between battery cells in the battery pack and the vehicle. When the battery is in a sleep mode, or when the battery is being installed or removed from a vehicle, the contactors may be placed in an open state so that they electrically decouple the battery cells in the battery pack from the battery pack load. On the other hand, when the battery pack is supplying power to propel the vehicle, for example, the contactors are placed in a closed state such that current may flow to and from battery cells to the vehicle load.

The inventors herein have determined that while a contactor may electrically isolate the battery pack from the vehicle, the contactor may also cause other issues. In particular, when an operating coil of a contactor is controlled by a pulse width modulated (PWM) signal to open or close a contactor, electromagnetic interference (EMI) may be produced by the switching PWM signal. Under some conditions it may be desirable to reduce or limit EMI produced by controlling the contactor because EMI may degrade operation of the battery pack or vehicle systems.

In addition, the inventors have determined that it may be beneficial to adjust the hold current supplied to the contactor coil in response to the vehicle drive mode. When the holding current supplied to the contactor coil is adjusted in response to vehicle drive mode, battery energy may be conserved.

Therefore, the inventors herein have developed a system for controlling a contactor of a battery pack. In one embodiment, the inventors have developed a system for controlling a battery pack contactor, comprising: a first power supply; a first switch; a contactor; and a controller including instructions for selectively actuating said contactor with said first power supply via said first switch, said controller including instructions to adjust a contactor a contactor holding voltage supplied to a coil of said contactor to more than two levels.

By varying an output voltage of a power supply to more than two voltage levels, EMI produced when controlling a contactor coil may be reduced. For example, the output voltage of a power supply may be adjusted to a plurality of levels to vary coil holding current. In one embodiment, the power supply voltage may be adjusted in response to a temperature of the contactor coil. In another embodiment, the power supply voltage may be adjusted in response to the vehicle drive mode. Further, the power supply voltage may be adjusted such that the voltage changes at a limited rate. In this way, the holding current supplied to the contactor coil can be adjusted without switching the output voltage. As a result, less EMI may be produced when the contactor coil is controlled.

The present description may provide several advantages. In particular, the approach may produce less EMI when controlling the coil of a contactor. Further, the approach may use less power when the current supplied to the contactor coil is varied in response to vehicle drive mode. Further still, the battery pack may have less electrical noise as noise from switching the contactor coils is reduced.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an exploded schematic view of a battery pack or assembly;

FIG. 2 shows a schematic view of an exemplary battery module;

FIG. 3 shows an exploded schematic view of an exemplary battery cell stack;

FIG. 4 shows a schematic view of a battery pack contactor control system;

FIG. 5 shows a schematic of a circuit for controlling a battery pack contactor;

FIG. 6 shows a schematic view of an alternate battery pack contactor control system;

FIG. 7 shows a flow chart illustrating a method for controlling a battery pack contactor;

FIG. 8 shows a continuation of the flow chart illustrated in FIG. 7;

FIG. 9 shows an example plot of contactor coil current during activation of a battery pack contactor; and

FIG. 10 shows an example plot of contactor coil current during activation of a battery pack contactor when control of the contactor plunger has degraded.

### DETAILED DESCRIPTION OF THE DEPICTED EMBODIMENTS

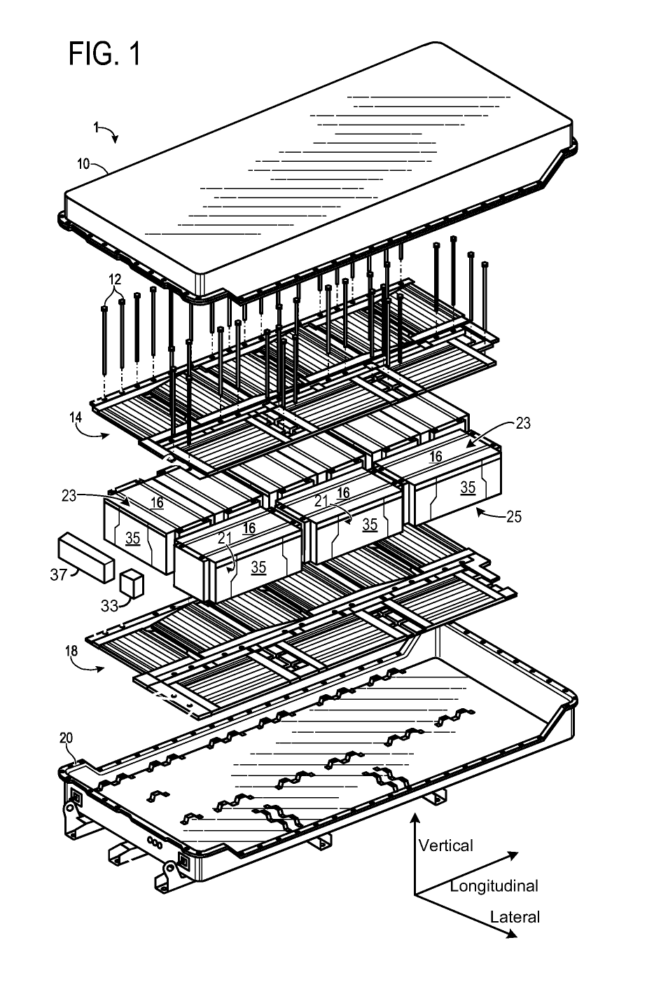

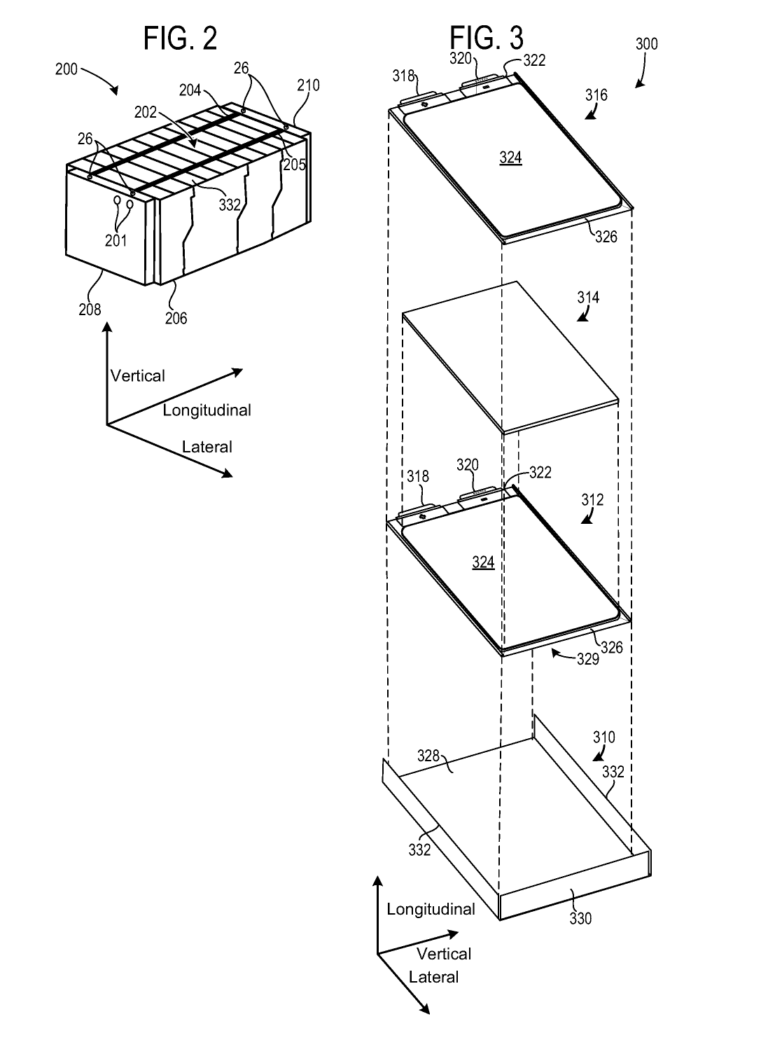

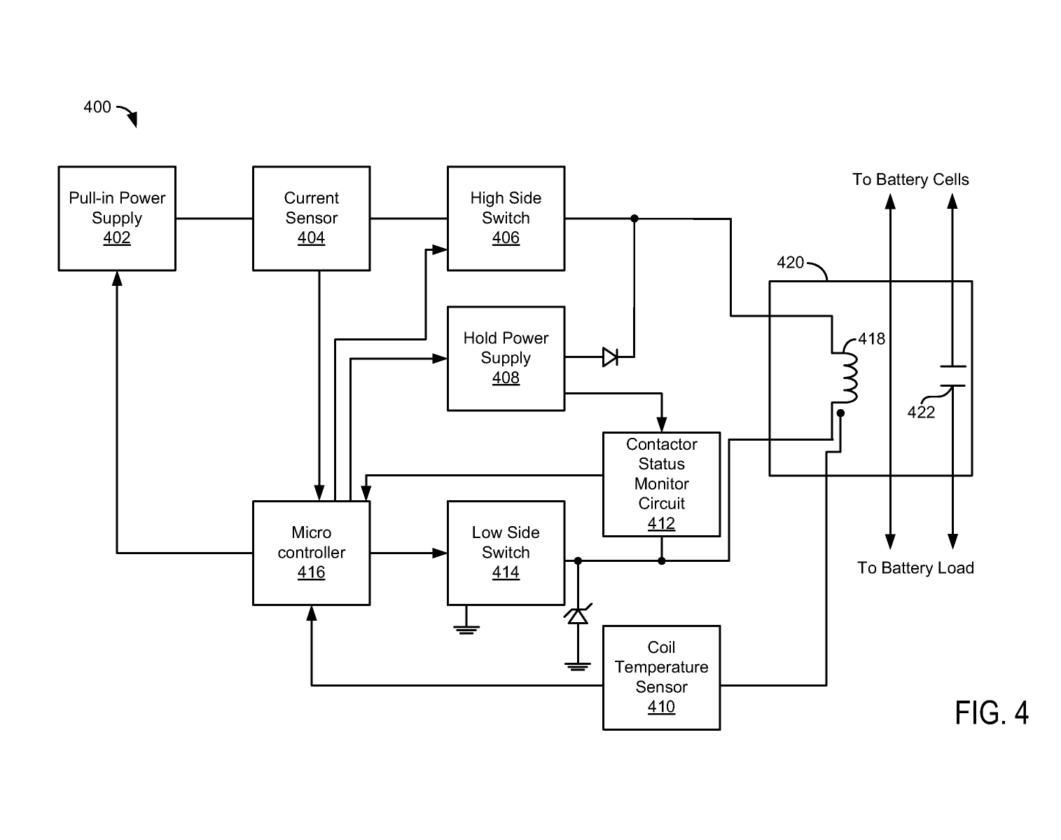

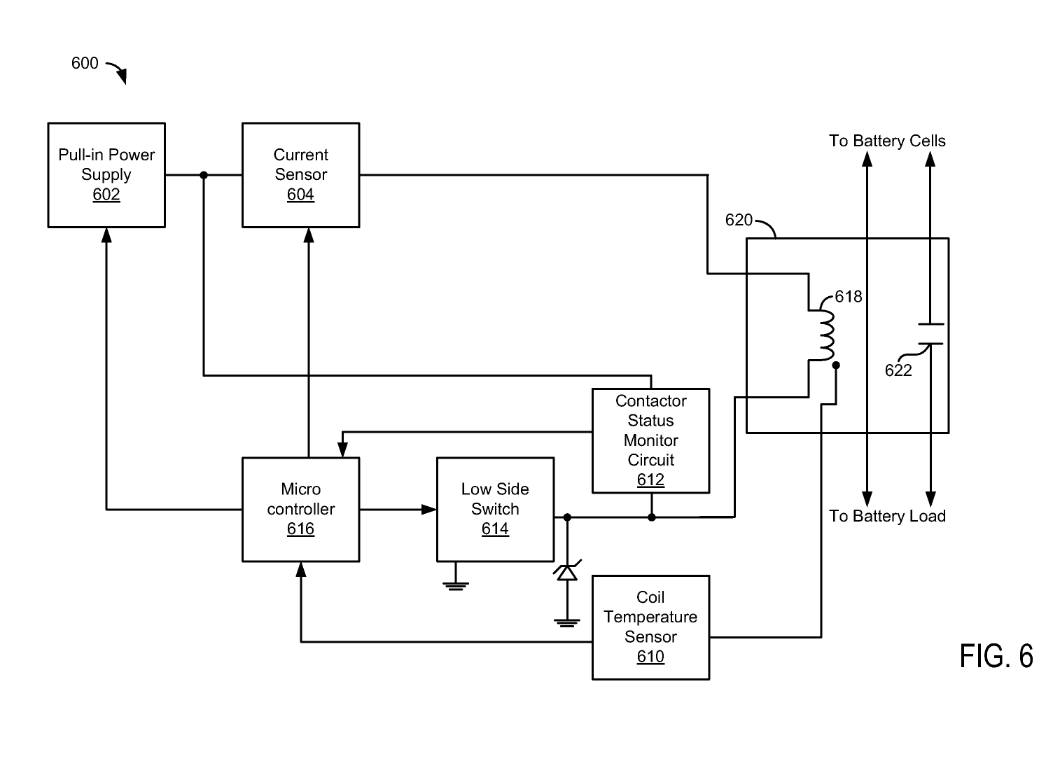

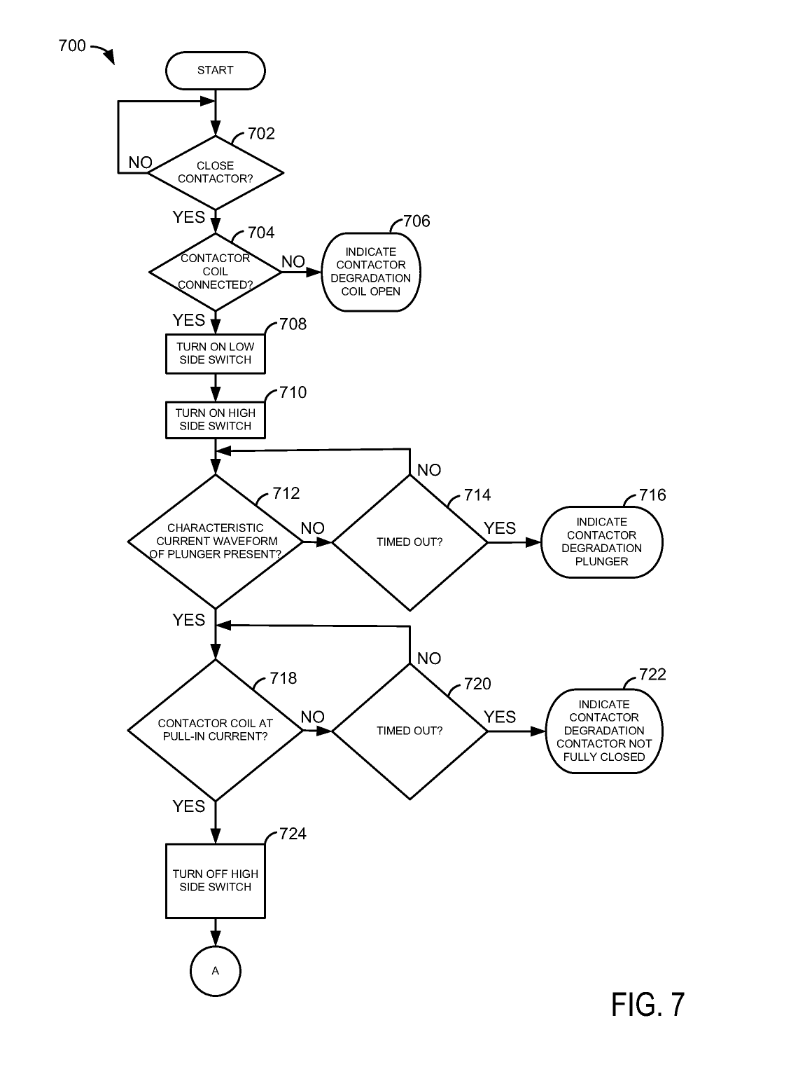

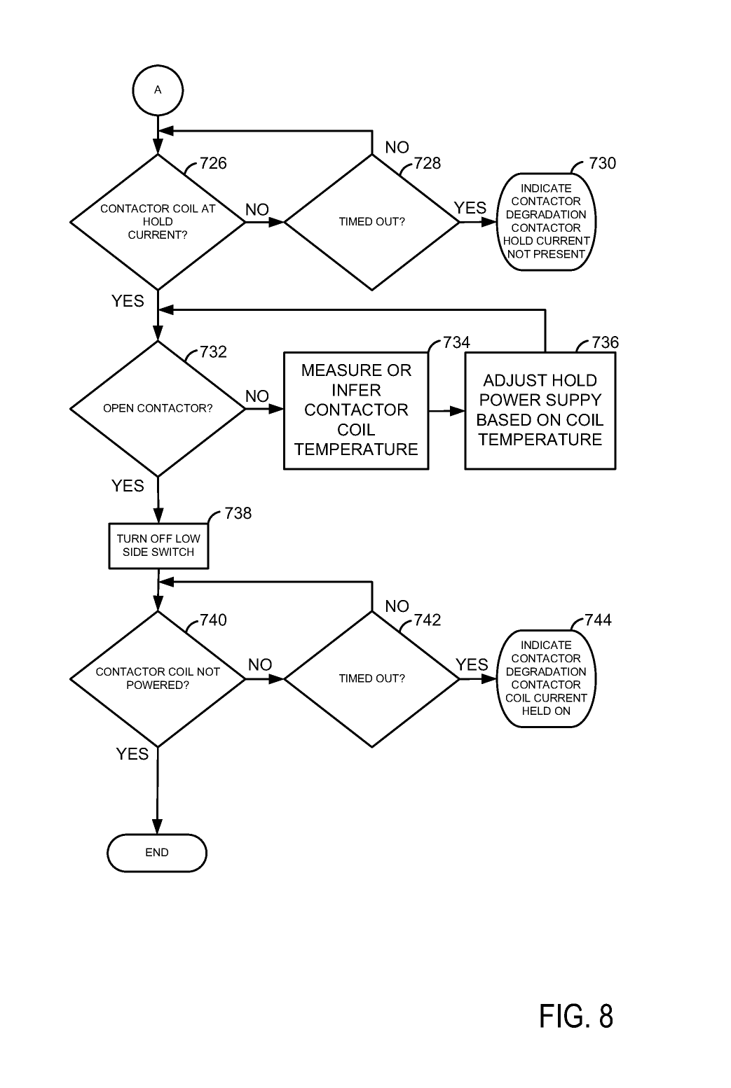

The present description is related to controlling a coil of a contactor that is capable of coupling cells of a battery pack to a load external to the battery pack. In one embodiment, battery cells such as those illustrated in FIG. 2 may be combined in a battery pack as illustrated in FIG. 1. The power from the battery cells may be selectively delivered to a load external to the battery pack via a contactor as illustrated by FIGS. 4 and 6. The contactor may be controlled by a microcontroller that executes a routine as shown in FIGS. 7 and 8.

The contactor may be supplied a voltage that varies in magnitude from a power supply. In particular, the power supply output voltage may be commanded to a plurality of voltage levels in response to an analog voltage or in response to a digital instruction from a microcontroller. Further, the rate at which the voltage level is varied may be limited so as to reduce the rate of voltage change (dV/dt) and current change (dI/dt), thereby reducing EMI within the battery pack. In addition, the holding current supplied to the contactor coil may be varied with drive mode so that battery pack power consumption may be reduced. For example, when the vehicle is in a charging mode and not moving less current may be delivered to the contactor coil as compared to when the vehicle is in the power delivering mode and providing power to propel a vehicle. In another example, the current supplied to the contactor coil may be increased or decreased in response to a vehicle accelerometer that indicates road conditions.

FIG. 1 shows an exploded view of a battery assembly 1. The battery assembly may include a cover 10, coupling devices 12, a first cooling subsystem 14 (e.g., cold plate), a plurality of battery modules 16, a second cooling subsystem 18 (e.g., cold plate), and a tray 20. The cover may be attached to the tray via a suitable coupling device (e.g., bolts, adhesive, etc.,) to form a housing surrounding the coupling devices, the cooling subsystems, and the battery modules, when assembled.

The battery modules 16 may include a plurality of battery cells configured to store energy. Although a plurality of battery modules are illustrated, it will be appreciated that in other examples a single battery module may be utilized. Battery modules 16 may be interposed between the first cooling subsystem 14 and the second cooling subsystem 18, where the battery modules are positioned with their electrical terminals on a side 21 facing out between the cooling subsystems.

Each battery module may include a first side 23 and a second side 25. The first and the second side may be referred to as the top and bottom side, respectively. The top and bottom sides may flank the electrical terminals, discussed in greater detail herein with regard to FIGS. 2-3. In this example, the top side of each battery module is positioned in a common plane in the battery assembly. Likewise the bottom side of each battery module is positioned in another common plane in the battery assembly. However, in other examples only the top side or the bottom side of each battery module may be positioned in a common plane. In this way, the cooling subsystems may maintain direct contact with the top sides and the bottom sides of the battery modules to increase heat transfer and improve cooling capacity, as described in further detail herein, wherein the cooling subsystems and the battery modules may be in face-sharing contact. Additional details of an exemplary battery module are described herein with regard to FIGS. 2-3. In alternate examples, only one of the cooling subsystems may be included in battery assembly 1, such as an upper cooling subsystem (subsystem 14 in this example). Moreover, the position, size, and geometry of the first and second cooling subsystems are exemplary in nature. Thus, the position, size, and/or geometry of the first and/or second cooling subsystems may be altered in other examples based on various design parameters of the battery assembly.

Battery assembly 1 may also include an electrical distribution module 33 (EDM), monitor and balance boards 35 (MBB), and a battery control module 37 (BCM). Voltage of battery cells in battery modules 16 may be monitored and balanced by MBBs that are integrated onto battery modules 16. MBBs may include a plurality of current, voltage, and other sensors. The EDM controls the distribution of power from the battery pack to the battery load. In particular, the EDM contains contactors for coupling high voltage battery power to an external battery load such as an inverter. The BCM provides supervisory control over battery pack systems. For example, the BCM may control ancillary modules within the battery pack such as the EDM and cell MBB, for example. Further, the BCM may be comprised of a microprocessor having random access memory, read only memory, input ports, real time clock, output ports, and a controller area network (CAN) port for communicating to systems outside of the battery pack as well as to MBBs and other battery pack modules.

FIG. 2 shows an exemplary battery module 200 that may be included in the plurality of battery modules 16, shown in FIG. 1. Battery module 200 may include a battery cell stack having a plurality of stacked battery cells and output terminals 201. The stacked arrangement allows the battery cells to be densely packed in the battery module.

FIG. 3 shows an exploded view of a portion of an exemplary battery cell stack 300. As shown the battery cell stack is built in the order of a housing heat sink 310, battery cell 312, compliant pad 314, battery cell 316, and so on. However, it will be appreciated that other arrangement are possible. For example, the battery cell stack may be built in the order of a housing heat sink, battery cell, housing heat sink, etc. Further in some examples, the housing heat sink may be integrated into the battery cells.

Battery cell 312 includes cathode 318 and anode 320 for connecting to a bus (not shown). The bus routes charge from a plurality of battery plates to output terminals of a battery pack and is coupled to bus bar support 322. Battery cell 312 further includes prismatic cell 324 that contains electrolytic compounds. Prismatic cell 324 is in thermal communication with cell heat sink 326. Cell heat sink 326 may be formed of a metal plate with the edges bent up 90 degrees on one or more sides to form a flanged edge. In the example of FIG. 3, two opposing sides include a flanged edge. However, other geometries are possible. Battery cell 312 is substantially identical to battery cell 316. Therefore similar parts are labeled accordingly. Battery cells 312 and 316 are arranged with their terminals in alignment and exposed. In battery module 200 shown in FIG. 2 the electric terminals are coupled to enable energy to be extracted from each cell in the battery module. Returning to FIG. 3, compliant pad 314 is interposed between battery cell 312 and battery cell 316. However, in other examples the compliant pad may not be included in the battery cell stack.

Housing heat sink 310 may be formed by a metal plate having a base 328 with the edges bent up 90 degrees on one or more sides to form a flanged edge. In FIG. 3 longitudinally aligned edge 330 and vertically aligned edges 332 are bent flanged edges. As depicted the housing heat sink are sized to receive one or more battery cells. In other words, one or more battery cells may be positioned within base 328. Thus, the flanged edges of the battery cells may be in contact with housing heat sink and underside 329 of battery cell 312 may be in contact with the base of the housing heat sink, facilitating heat transfer.

One of the longitudinally aligned edges 332 of the housing heat sink 310 may form a portion of the top side 202 of battery module 200, as shown in FIG. 2. Similarly, one of the longitudinally aligned edges 332 may form a portion of the bottom side of the battery module. Thus, the longitudinally aligned edges of the housing heat sink may be in contact with the first and the second cooling subsystems to improve heat transfer. In this way, heat may be transferred from the battery cells to the exterior of the battery module.

The battery cells may be strapped together by binding bands 204 and 205. The binding bands may be wrapped around the battery cell stack or may simply extend from the front of the battery cell stack to the back of the battery cell stack. In the latter example, the binding bands may be coupled to a battery cover. In other embodiments, the binding bands may be comprised of threaded studs (e.g., metal threaded studs) that are bolted at the ends. Further, various other approaches may be used to bind the cells together into the stack. For example, threaded rods connected to end plates may be used to provide the desired compression. In another example, the cells may be stacked in a rigid frame with a plate on one end that could slide back and forth against the cells to provide the desired compressive force. In yet other embodiments, rods held in place by cotter pins may be used to secure the battery cells in place. Thus, it should be understood that various binding mechanisms may be used to hold the cell stack together, and the application is not limited to metal or plastic bands. Cover 206 provides protection for battery bus bars (not shown) that route charge from the plurality of battery cells to output terminals of the battery module.

The battery module may also include a front end cover 208 and a rear end cover 210 coupled to the battery cell stack. The front and rear end covers include module openings 26. However, in other examples the module openings may be included in a portion of the battery module containing battery cells.

Referring now to FIG. 4, a schematic view of a battery back contactor control system is shown. Contactor control system 400 includes a pull-in power supply 402 for supplying current to the contactor coil 418 of contactor 420. In one example, power supply 402 is a voltage supply that supplies current through high side switch 406, contactor coil 418, and low side switch 414, to close normally open contacts 422. When contacts 422 are closed power from battery cells may be delivered to a load external to the battery pack. Normally open contacts can close when current from pull-in power supply 402 passes through contactor coil 418. Pull-in power supply 402 has capacity to source a higher level current than hold power supply 408. Hold power supply 408 may keep contacts 422 closed after a plunger (not shown) that couples coil 418 to contacts 422 has been moved with current supplied by pull-in power supply 402. Current sensor 404 is configured to monitor current supplied by pull-in power supply 402 to contactor coil 418. In one embodiment, current sensor 404 may be a shunt current sensor. In another embodiment, current sensor 404 may be of a coil configuration. Contactor status monitor circuit 412 provides an indication of voltage across contactor coil 418. In one embodiment, the contactor coil voltage is monitored by an analog to digital converter (ADC) in microcontroller 416. Low side switch 414 selectively couples one side of contactor coil 418 to ground. Coil temperature sensor 410 monitors the temperature of contactor coil 418. Coil temperature sensor 410 may be a thermistor, thermocouple, or other type of temperature sensor. In an alternative embodiment, coil temperature may be inferred from ambient temperature and the amount of current passing through contactor coil 418.

Microcontroller 416 is configured to issue commands to hold power supply 408. In one example, microcontroller 416 issues voltage output commands to hold power supply 408 by way of a digital to analog converter (DAC). In another example, microcontroller 416 issues voltage output commands in a digital format by way of a controller area network (CAN). Microcontroller 416 also has digital outputs to control high side switch 406 and low side switch 414 in response to analog input from current sensor 404, status monitor circuit 412, and coil temperature sensor 410.

High side switch 406 and low side switch 414 may be comprised of field effect transistors, bipolar-junction transistors, or other types of switching devices. Contactor status monitor circuit 412 may be comprised of a resistor network for sensing voltage at the low side end of coil 418. In one embodiment, a voltage that develops between resistors connected to the low side end of coil 418 is monitored to determine the operational status of contactor coil 418.

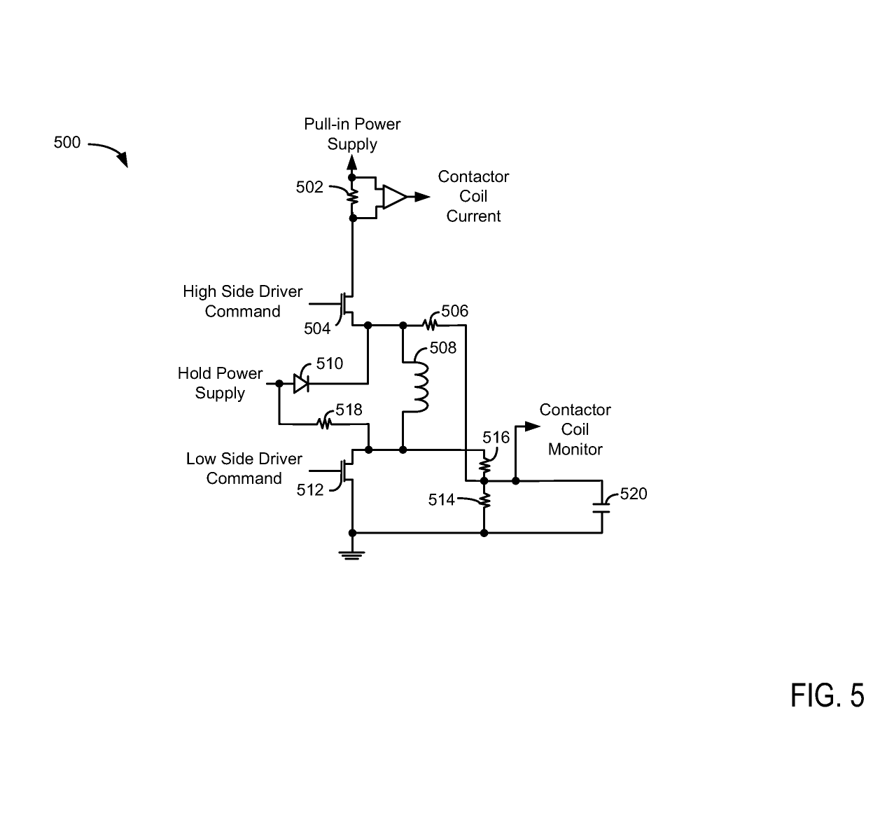

Referring now to FIG. 5, a circuit for controlling a battery pack contactor is shown. The circuit of FIG. 5 is one example of the system described in FIG. 4. Circuit 500 includes resistor 502 for sensing current from pull-in power supply to contactor coil 508. In one example, the voltage measured across resistor 502 is amplified and sent as a signal (e.g., Contactor Coil Current) to a microcontroller. Circuit 500 also includes high side driver transistor 504 that is turned on and off by a microcontroller signal (e.g., High Side Driver Command). High side driver transistor may be a FET, bipolar transistor, or other type of switching device. Circuit 500 also includes diode 510 to limit current flow into the hold power supply from the pull-in power supply. Contactor coil 508 activates and closes normally open contacts (not shown) when current from pull-in power supply passes through high side driver transistor 504 and low side drive transistor 512. Low side driver 512 is commanded by a signal from a microcontroller (e.g., Low Side Driver Command). Resistors 506 and 514 are electrically coupled in parallel to coil 508 and provide an indication of the state of contactor coil 508. Resistor 516 couples resistors 506 and 514 to one side of contactor coil 508. The state of the contactor coil may be observed by sensing the voltage between resistors 516 and 514. Capacitor 520 filters voltage between resistors 514 and 516. In one example, a signal from between resistors 516 and 514 is provided to a microcontroller (e.g., signal Contactor Coil Monitor). Resistor 518 adjusts the voltage between resistors 516 and 514 when low side driver 512 is open.

In one example, the contactor coil monitor of FIG. 5 provides the following contactor state information via voltage output between resistors 516 and 514. A voltage output of less than 0.12 volts indicates an invalid monitor state. A voltage output of between 0.12 and 0.21 volts indicates high side driver 504 off, low side driver 512 on. A voltage output of between 0.21 and 0.24 volts indicates an invalid monitor state. A voltage output of between 0.24 and 0.3 volts indicates high side driver 504 off, low side driver 512 off, contactor not connected. A voltage output of between 0.3 and 0.37 volts indicates high side driver 504 off, low side driver 512 off, contactor connected. A voltage output of between 0.37 volts and 0.41 volts indicates invalid monitor state. A voltage output of between 0.41 and 0.55 volts indicates high side driver 504 on, low side driver 512 on, look at contactor power current to determine contactor connected. A voltage output of between 0.55 and 0.68 volts indicates high side driver 504 on, low side driver 512 off, contactor not connected. A voltage output of between 0.68 and 0.88 volts indicates invalid monitor state. A voltage output of between 0.88 and 1 volt indicates high side driver 504 on, low side driver 512 off, contactor connected. A voltage output of greater than 1 volt indicates an invalid monitor state.

In this way, the resistor array including resistors 516 and 514 provides contactor state information for monitoring the battery output contactor. Of course, the voltage output levels indicated above are simply illustrative of monitor operation and are not to be interpreted in a limiting sense.

Referring now to FIG. 6, an alternative battery pack contactor control system is shown. The control system illustrated in FIG. 6 is similar to the one shown in FIG. 4; however, the contactor control system of FIG. 6 does not include a hold power supply.

Contactor control system 600 includes a pull-in power supply 602 for supplying current to the contactor coil 618 of contactor 620. In one example, power supply 602 is a voltage supply that supplies a plurality of voltage levels to contactor coil 618. Thus, power supply 602 supplies pull-in current and hold current to contactor coil 618. When current flows through contactor coil 618 and low side switch 614, normally open contacts 622 can close. When contacts 622 are closed power from battery cells may be delivered to a load external to the battery pack. Normally open contacts can close when current from pull-in power supply 602 passes through contactor coil 618. Pull-in power supply 602 has capacity to source a pull-in current and hold current supplied to contactor coil 618. Pull-in power supply 602 may keep contacts 622 closed after a plunger (not shown) that couples contactor coil 618 to contacts 622 has been moved with current supplied by pull-in power supply 602. Current sensor 604 is configured to monitor current supplied by pull-in power supply 602 to contactor coil 618. In one embodiment, current sensor 604 may be a shunt current sensor. In another embodiment, current sensor 604 may be of a coil configuration. Contactor status monitor circuit 612 provides an indication of voltage at one end of contactor coil 618. In one embodiment, the voltage at one end of the contactor coil is monitored by an analog to digital converter (ADC) in microcontroller 616. Low side switch 614 selectively couples one side of contactor coil 618 to ground. Coil temperature sensor 610 monitors the temperature of contactor coil 618. Coil temperature sensor 610 may be a thermistor, thermocouple, or other type of temperature sensor. In an alternative embodiment, coil temperature may be inferred from ambient temperature and the amount of current passing through contactor coil 618.

Microcontroller 616 is configured to issue commands to pull-in power supply 602. In one example, microcontroller 616 issues voltage output commands to pull-in power supply 602 by way of a digital to analog converter (DAC). In another example, microcontroller 616 issues voltage output commands in a digital format by way of a controller area network (CAN). During pull-in of coil 618, microcontroller 616 can issue a first command for a first level of current. After coil pull in is confirmed from coil current, a second command for a second current, lower than the first level current, can be issued from microcontroller 616 to pull-in power supply 602. Microcontroller 616 also has a digital output to control low side switch 614 in response to analog input from current sensor 604, status monitor circuit 612, and coil temperature sensor 610.

Low side switch 614 may be comprised of a field effect transistor, bipolar-junction transistors, or other types of switching device. Contactor status monitor circuit may be comprised of a resistor network for sensing voltage at one end of contactor coil 618. In one embodiment, a voltage that develops between resistors connected to one end of contactor coil 618 is monitored to determine the operational status of contactor coil 618.

Thus, the systems described in FIGS. 1-6 provide for a system for controlling a battery pack contactor, comprising: a first power supply; a first switch; a contactor; and a controller including instructions for selectively actuating said contactor with said first power supply via said first switch, said controller including instructions to adjust a contactor holding voltage supplied to a coil of said contactor to more than two levels. In this way, power used to operate the controller can be reduced based on vehicle operating conditions. The system further comprises, a second power supply and a second switch, the second switch in communication with the first power supply and the contactor, the second switch in a second circuit coupling the first power supply and the contactor, the second switch positioned in the second circuit between the first power supply and the contactor, the first switch in a first circuit coupling the contactor and ground, the first switch positioned in the first circuit between the contactor and s the ground, the second power supply in communication with the contactor at a location between the second switch and the contactor. The system also includes a power supply having a voltage or current output. In one example, the system includes a power supply that outputs a substantially constant voltage during contactor pull-in. In some examples, the system further includes a diode located between the second power supply and the contactor.

The systems described herein also provide for controlling a battery pack contactor of a vehicle, comprising a first power supply; a first switch; a contactor; and a controller including instructions for selectively coupling said first power supply to said contactor via said first switch, said controller including instructions to adjust a contactor hold voltage in response to a vehicle drive mode. In one example, the system includes a first drive mode that is a charging mode when the vehicle is stopped and charged by a power source external to the vehicle, and wherein a second drive mode is a mode where the vehicle is moving. The system further comprises a second power supply and a second switch, the second switch in communication with the first power supply and the contactor, the second switch in a second circuit coupling the first power supply and the contactor, the second switch positioned in the second circuit between the first power supply and the contactor, the first switch in a first circuit coupling the contactor and ground, the first switch positioned in the first circuit between the contactor and the ground, the second power supply in communication with the contactor at a location between the second switch and the contactor. In one example, the system includes a first power supply that is a power supply that outputs a substantially constant voltage during contactor pull-in. The system further comprises a diode located between the second power supply and the contactor. The system further comprises a voltage detection circuit having a first side electrically coupled downstream of the first voltage supply, the voltage detection circuit having a second side electrically coupled downstream of the contactor and upstream of ground. The system including a current sensor configured to monitor current from the first voltage supply. The system also includes a first switch and a second switch that are transistors. The system also includes a controller with instructions for adjusting an output of the first power supply.

The systems also provide for controlling a battery pack contactor, comprising: a first power supply; a second power supply; a contactor; and a first switch and a second switch, said first switch in communication with said first power supply and said contactor, said first switch in a first circuit coupling said first power supply and said contactor, said first switch positioned in said first circuit between said first power supply and said contactor, said second switch in a second circuit coupling said contactor and ground, said second switch positioned in said second circuit between said contactor and ground, said second power supply in communication with said contactor at a location between said first switch and said contactor. The system also includes wherein an output of the first power supply is a voltage or a current.

Referring now to FIG. 7, a flow chart illustrating a method for controlling a battery pack contactor is shown. The method of FIG. 7 may be used to control the systems and circuits illustrated in FIGS. 4-6.

At 702, routine 700 judges whether or not the battery pack output contactor is to be closed so that battery power may be delivered to a load external to the battery pack. The contactor may be closed in response to a driver entering a vehicle and shifting into drive. If there is a request for battery power to be delivered external to the battery pack, routine 700 proceeds to 704. If the contactor is open and there is no request for battery power external to the battery pack, routine 700 remains at 702. It should be noted that routine 700 is one of many routines that may be executed simultaneously by the BCM microcontroller.

At 704, routine 700 judges whether or not the contactor coil is connected to the contactor control circuitry (e.g., the circuitry illustrated in FIGS. 4 and 6). In one example, a resistor network is electrically coupled to one side of the contactor coil. A voltage is applied to one side of the resistor network and a voltage of the resistor network is monitored (see FIG. 5 for example). If the voltage at the resistor network is lower than a threshold value when switches (e.g., high side and low side drivers) supplying current to the contactor coil are open, then it may be determined that there is contactor coil degradation or that the coil is electrically uncoupled from the contactor coil control circuit. If it is judged that the contactor coil is not connected to the contactor coil control circuit, routine 700 proceeds to 706. Otherwise, routine 700 proceeds to 708.

At 706, routine 700 provides an indication of contactor coil degradation. In one example, a microcontroller in the BCM sets a flag and reports a condition of contactor degradation. Contactor degradation may be indicted to systems inside and outside of the battery pack. In one example, an indication of contactor degradation is provided to a vehicle controller by way of a CAN.

At 708, routine 700 turns on or activates a low side switch that couples one side of the contactor coil to ground (e.g. the low side switches as shown in FIGS. 4-5). The low side switch may be turned on by a digital output of a microcontroller. In one embodiment, when the low side switch is turned on current may start to flow from a hold voltage supply to the contactor coil. Turning on the low side driver allows the low side driver to conduct. Although current from the hold voltage supply is less than an amount of current to activate or turn on the contactor coil, the initial current flowing from the hold voltage supply can act to reduce current in-rush when a pull-in voltage supply is electrically coupled to the contactor coil. In one example, routine 700 may wait for a predetermined amount of time before proceeding to 710. Once the low side driver is activated routine 700 proceeds to 710.

At 710, routine 700 turns on or activates a high side switch that couples a contactor coil to a pull-in voltage supply. When the high side switch is turned on it may begin to conduct so that current flows from the pull-in power supply to the contactor coil. Once the high side driver is turned on, routine 700 proceeds to 712.

At 712, routine 700 monitors the characteristic current waveform produced when a plunger of the contactor is moved by flowing current though the contactor coil. In one embodiment, the BCM monitors the contactor coil current through a resistor and looks for a change in the sign of the derivative of the contactor coil current during a prescribed predetermined time period. In other embodiments, contactor coil operation may be assessed with other signal attributes such as rate of current rise or current level. If the characteristic current waveform is present, routine 700 proceeds to 718. Otherwise, routine 700 proceeds to 714. It should also be noted that predetermined attributes may be varied as a temperature of the contactor coil varies. For example, as the temperature of the contactor coil increases the predetermined rate of current rise may be reduced to compensate for increased contactor coil resistance. The predetermined attributes may also be varied as the voltage of the pull-in power supply varies.

At 714, routine 700 waits for a prescribed predetermined period of time to determine if the characteristic current waveform is present. If the waveform is not present and the predetermined amount of time has not expired, routine 700 returns to 712. If time has expired without the characteristic current waveform being observed, routine 700 proceeds to 716.

At 716, routine 700 provides an indication of contactor plunger degradation. In one example, a microcontroller in the BCM sets a flag and reports a condition of contactor plunger degradation. Contactor plunger degradation may be indicted to systems inside and outside of the battery pack. In one example, an indication of contactor degradation is provided to a vehicle controller by way of a CAN.

At 718, routine 700 judges whether or not contactor coil current has achieved a predetermined threshold current that represents the contactor pull-in current. The pull-in current is a current level required for the plunger to close the contactor contacts. In one example, the contactor coil current is compared to a predetermined current. If the contactor coil current exceeds the predetermined current level routine 700 proceeds to 724. Otherwise, routine 700 proceeds to 720. It should also be noted that the predetermined pull-in current may be varied as a temperature of the contactor coil varies. For example, as the temperature of the contactor coil increases the predetermined pull-in current may be reduced to compensate for increased contactor coil resistance. The predetermined pull-in current may also be varied as the voltage of the pull-in power supply varies.

At 720, routine 700 waits for a prescribed predetermined period of time to determine if the contactor current is at the pull-in current. If the contactor coil current is not at the pull-in current and a predetermined amount of time has not expired, routine 700 returns to 718. If time has expired without the contactor current reaching the pull-in current, routine 700 proceeds to 722.

At 722, routine 700 provides an indication of contactor engagement degradation. In one example, a microcontroller in the BCM sets a flag and reports a condition of contactor engagement degradation. Contactor engagement degradation may be indicted to systems inside and outside of the battery pack. In one example, an indication of contactor engagement degradation is provided to a vehicle controller by way of a CAN.

At 724, routine 700 turns off a high side driver. The high side driver may be turned off after the contacts of the contactor have closed and a higher level of current is not longer needed to keep the contactor engaged and the contacts closed. When the high side driver is turned off the high side driver stops conducting and the hold voltage supply begins supplying current to keep the contacts of the contactor closed. By switching power delivered to the contractor coil from the pull-in power supply to the hold power supply, it is possible to reduce the amount of energy consumed within the battery pack. Once the high side driver is switched off, routine 700 proceeds to 726.

Referring now to FIG. 8, the method of FIG. 7 continues. At 726, routine 700 judges whether or not the contactor coil is at the hold current. In one embodiment, the voltage of a contactor status circuit is monitored to determine whether or not the contactor current is at a predetermined hold current.

The hold current may also be adjusted in response to vehicle drive mode. In one example, the amount of hold current supplied to the contactor coil may be reduced when the vehicle is stationary and while the battery is charging. Further, the amount of hold current may be increased when the vehicle is moving. In still another embodiment, the contactor hold current may be reduced when the vehicle is being driven and battery power is delivered to a vehicle while the vehicle is stopped. In still another embodiment, holding current may be increased in response to a signal from a vehicle accelerometer or vehicle wheel speed sensor. For example, if the output of an accelerometer increases in response to the vehicle traveling down a rough road, the amount of contactor hold current may be increased so that contactor contacts remain positively engaged.

If routine 700 judges that the current flowing in the contactor coil is at the predetermined hold current, routine 700 proceeds to 732. Otherwise, routine 700 proceeds to 728.

At 728, routine 700 waits for a prescribed predetermined period of time to determine if the contactor current is at the hold current. If the contactor coil current is not at the hold current and a predetermined amount of time has not expired, routine 700 returns to 726. If time has expired without the contactor current reaching the hold current, routine 700 proceeds to 730.

At 730, routine 700 provides an indication of contactor hold current degradation. In one example, a microcontroller in the BCM sets a flag and reports a condition of contactor hold current degradation. Contactor hold current degradation may be indicted to systems inside and outside of the battery pack. In one example, an indication of contactor engagement degradation is provided to a vehicle controller by way of a CAN.

At 732, routine 700 judges whether or not there is a request to open the contactor. In one embodiment, routine 700 may receive a request to open the contactor from a vehicle controller. In another embodiment, routine 700 may receive a request to open the contactor from within the battery pack. If the contactor is judged to enter an open state, routine 700 proceeds to 738. Otherwise, routine 700 proceeds to 734.

At 734, routine 700 measures or infers the temperature of the contactor coil. In one embodiment the contactor coil temperature may be measured with a thermistor or a thermocouple. In another example, the contactor coil may be inferred from ambient temperature and the amount of current passing through the contactor coil. Routine 700 proceeds to 736 once the contactor coil temperature is determined.

At 736, the predetermined hold voltage may be adjusted as temperature of the coil varies. For example, if the coil temperature increases, the predetermined hold voltage may be increased to maintain the hold current constant even as the contactor coil resistance increases with the increase in the contactor coil temperature. Routine 700 returns to 732 once the hold voltage is adjusted in response to contactor coil temperature.

At 738, the low side switch is turned off to open the contactor contacts. When the low side switch is turned off it stops conducting thereby limiting current flow to the contactor coil. Routine 700 proceeds to 740 after the low side switch is turned off.

In one embodiment where a single power supply with an adjustable output (e.g., the power supply voltage or current output may be adjustable) supplies power to the contactor coil the rate that the output of the single power supply is adjusted may be limited. For example, the rate that the output voltage or current is changed over a period of time may be limited. In one example, the rate that voltage may be changed is limited to a rate of less than 10 volts per second. In an embodiment where two power supplies provide power to a contactor coil, adjustments to the hold current power supply may be limited.

At 740, routine 700 judges whether or not the contactor coil is not powered. In one example, a voltage of the contactor coil is monitored to determine if the contactor coil is not powered. If the contactor coil is not powered, routine 700 proceeds to exit. If routine 700 determines that the contactor coil is powered, routine 700 proceeds to 742. Note that when routine 700 exits, routine 700 may be re-executed such that the contactor coil state may be continuously controlled.

At 742, routine 700 waits for a prescribed predetermined period of time to determine if the contactor is not powered. If the contactor coil is powered and a predetermined amount of time has not expired, routine 700 returns to 740. If time has expired without the contactor not being powered, routine 700 proceeds to 744.

At 744, routine provides an indication of contactor held on degradation. In one example, a microcontroller in the BCM sets a flag and reports a condition of contactor held on degradation. Contactor held on degradation may be indicted to systems inside and outside of the battery pack. In one example, an indication of contactor held on degradation is provided to a vehicle controller by way of a CAN.

Thus, the method of FIGS. 7-8 provides for a method for controlling a contactor coil of a battery coupled in a vehicle, comprising: selectively coupling a first power supply to a contactor; and adjusting a hold voltage supplied to said contactor in response to a vehicle drive mode. In this way, the amount of energy supplied to hold the contactor can be varied to reduce power consumption within the battery pack. The method further comprises coupling the first power supply to the contactor during contactor pull-in, and coupling a second power supply to the contactor after the contactor pull-in, the second power supply providing holding voltage to the contactor. The method includes wherein the first power supply is electrically decoupled from the contactor after the second power supply is electrically coupled to the contactor. The method also includes wherein an output of the first power supply is increased in response to a rough road vehicle drive mode. The method also includes wherein the hold current is adjusted in response to a temperature of a coil of the contactor. In one example, the method includes wherein the first power supply is electrically coupled to the contactor via a first switch and a second switch. A method also includes wherein the second power supply is electrically coupled to the contactor after a current flowing into a coil of the contactor reaches a threshold current. In another example, the method includes wherein the second switch is driven to an open state after the contactor is pulled in. The method also includes wherein the holding current is adjusted by varying an output voltage of the first power supply to more than two voltage levels.

Further, the method of FIGS. 7-8 also provides for controlling a contactor coil, comprising: coupling a first power supply to a contactor; coupling a second power supply to the contactor when a current flowing into a coil of the contactor reaches a threshold; and decoupling the first power supply from the contactor after the second power supply is electrically coupled to the contactor. The method also includes wherein first power supply is electrically coupled to the contactor via first and second switches. The method further includes wherein the switches are transistors, and wherein the current provided by the second power supply is adjusted in response to a vehicle drive mode.

Further still, the method of FIGS. 7-8 also provides for controlling a contactor coil, comprising: coupling a first power supply to a contactor; coupling a second power supply to the contactor when a current flowing into a coil of the contactor reaches a threshold; and decoupling the first power supply from the contactor after the second power supply is electrically coupled to the contactor. The method also includes wherein the first power supply is electrically coupled to the contactor via first and second switches. The method also includes wherein the switches are transistors, and wherein a voltage provided by the second power supply is adjusted in response to a vehicle drive mode.

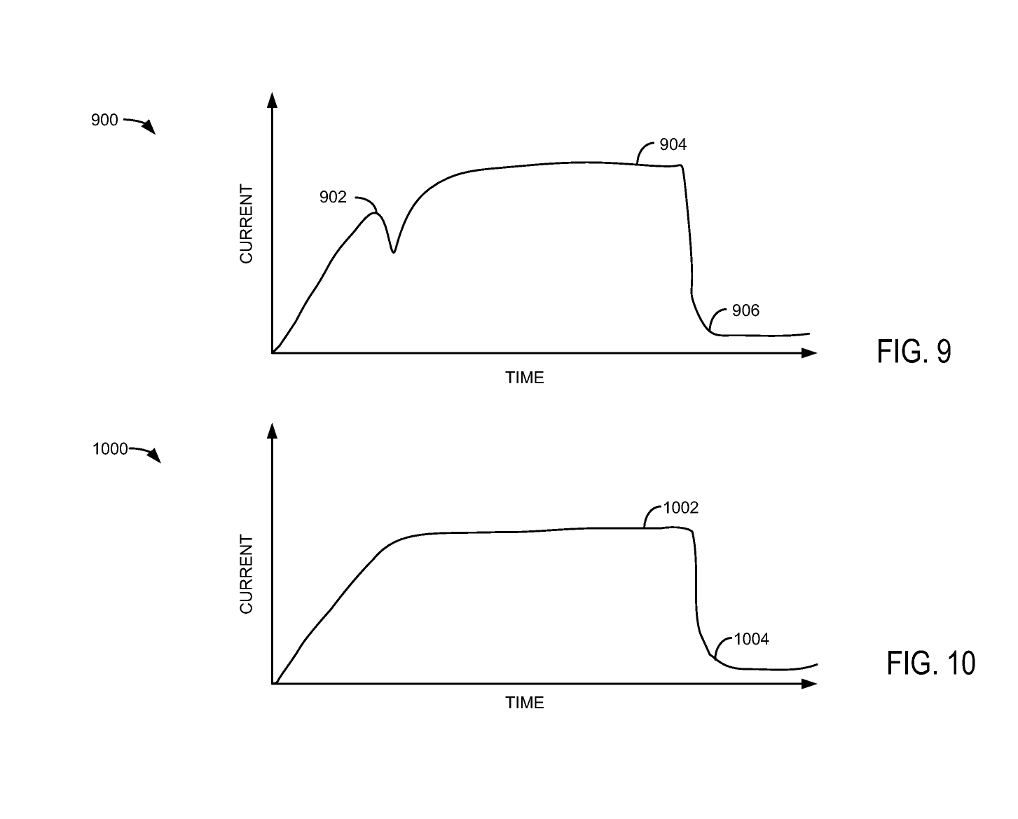

Referring now to FIG. 9, an example plot of contactor coil current during activation of a battery pack contactor is shown. Time in plot 900 begins at the left and increases to the right as indicated by the arrow on the X-axis. Current flowing into the contactor coil increases in the direction as indicated by the arrow of the Y-axis. Contactor coil current begins at zero and increases in accordance with a first order response until 902 at which time the current briefly decreases and then increases again. In this region, the derivative of current changes its sign from positive to negative. The current profile of FIG. 9 is the result of the contactor plunger moving in the contactor coil's magnetic field and then stopping as the plunger reaches the end of its stroke. Thus, contactor coil operation including plunger movement may be determined from the derivative of contactor coil current at a predetermined time after applying current to the contactor coil. At 904, the coil current has reached the contactor pull-in current. Shortly thereafter, the contactor coil current is reduced to the hold current at 906.

Referring now to FIG. 10, an example plot of contactor coil current during activation of a battery pack contactor when control of the contactor plunger has degraded is shown. Time in plot 1000 begins at the left and increases to the right as indicated by the arrow on the X-axis. Current flowing into the contactor coil increases in the direction as indicated by the arrow of the Y-axis. Contactor coil current begins at zero and increases in accordance with a first order response. The current trajectory in FIG. 10 does not exhibit the inflection in current that is shown at 902 of FIG. 9. Since the plunger of the contactor shown in FIG. 10 does not move, the current inflection is not shown and the coil current files a first order response. Thus, the absence of plunger movement may be determined from the derivative of contactor coil current remaining positive at a predetermined time after applying current to the contactor coil. At 1002, the coil current has reached the contactor pull-in current. Shortly thereafter, the contactor coil current is reduced to the hold current at 1004.

The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system for controlling a battery pack contactor, comprising:
a first power supply;
a first switch;
a contactor; and
a controller including instructions for selectively actuating said contactor with said first power supply via said first switch, said controller including instructions to adjust a contactor holding voltage supplied to a coil of said contactor to more than two levels.

2. The system of claim 1, further comprising a second power supply and a second switch, said second switch in communication with said first power supply and said contactor, said second switch in a second circuit coupling said first power supply and said contactor, said second switch positioned in said second circuit between said first power supply and said contactor, said first switch in a first circuit coupling said contactor and ground, said first switch positioned in said first circuit between said contactor and said ground, said second power supply in communication with said contactor at a location between said second switch and said contactor.

3. The system of claim 1, wherein said output of said first power supply is a voltage or a current.

4. The system of claim 1, wherein said first power supply is a power supply that outputs a substantially constant voltage during contactor pull-in.

5. The system of claim 2, further comprising a diode located between said second power supply and said contactor.

6. A system for controlling a battery pack contactor of a vehicle, comprising:
a first power supply;
a first switch;
a contactor; and
a controller including instructions for selectively coupling said first power supply to said contactor via said first switch, said controller including instructions to adjust a contactor hold voltage in response to a vehicle drive mode.

7. The system of claim 6 wherein a first drive mode is a charging mode when said vehicle is stopped and charged by a power source external to said vehicle, and wherein a second drive mode is a mode where said vehicle is moving.

8. The system of claim 6, further comprising a second power supply and a second switch, said second switch in communication with said first power supply and said contactor, said second switch in a second circuit coupling said first power supply and said contactor, said second switch positioned in said second circuit between said first power supply and said contactor, said first switch in a first circuit coupling said contactor and ground, said first switch positioned in said first circuit between said contactor and said ground, said second power supply in communication with said contactor at a location between said second switch and said contactor.

9. The system of claim 6, wherein said first power supply is a power supply that outputs a substantially constant voltage during contactor pull-in.

10. The system of claim 8, further comprising a diode located between said second power supply and said contactor.

11. The system of claim 6, further comprising a voltage detection circuit having a first side electrically coupled downstream of said first voltage supply, said voltage detection circuit having a second side electrically coupled downstream of said contactor and upstream of ground.

12. The system of claim 6, further comprising a current sensor configured to monitor current from said first voltage supply.

13. The system of claim 8, wherein said first switch and said second switch are transistors.

14. The system of claim 6, wherein said controller includes instructions for adjusting an output of said first power supply.

15. A method for controlling a contactor coil of a battery coupled in a vehicle, comprising:
selectively coupling a first power supply to a contactor; and
adjusting a hold voltage supplied to said contactor in response to a vehicle drive mode.

16. The method of claim 15, further comprising coupling said first power supply to said contactor during contactor pull-in, and coupling a second power supply to said contactor after said contactor pull-in, said second power supply providing holding voltage to said contactor.

17. The method of claim 16, wherein said first power supply is electrically decoupled from said contactor after said second power supply is electrically coupled to said contactor.

18. The method of claim 15, wherein an output of said first power supply is increased in response to a rough road vehicle drive mode.

19. The method of claim 15, wherein said hold current is adjusted in response to a temperature of a coil of said contactor.

20. The method of claim 15, wherein said first power supply is electrically coupled to said contactor via a first switch and a second switch.
